(19) United States
(12) Patent Application Publication
(10) Pub. No.: US 2005/0125667 A1
(43) Pub. Date: Jun. 9, 2005

(54) Systems and methods for authorizing delivery of incoming messages

(76) Inventors: Tim Sullivan, Portola Valley, CA (US); Jay Logue, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/747,557

(22) Filed: Dec. 29, 2003

Related U.S. Application Data
(60) Provisional application No. 60/528,154, filed on Dec. 9, 2003.

(51) Int. Cl. H04L 9/00

(52) U.S. Cl. 713/170

(57) ABSTRACT

Delivery tickets that include data and a checksum are used to authenticate incoming electronic messages on behalf of a user. The delivery ticket is located in a field in the envelope portion or in a header in the content portion of outgoing electronic messages. A bounce message or a reply message generated by a remote computer in response to the outgoing electronic message includes the delivery ticket. When the bounce message or the reply message is received by an authentication server associated with the user, the delivery ticket is authenticated to determine whether to deliver the incoming message to the user. The delivery ticket is initially validated if a checksum regenerated by applying a private key to the data of the delivery ticket is the same as the checksum included in the delivery ticket. The validation process also includes determining whether the delivery ticket complies with rules that specify the duration of time of the validity or the number of times that the delivery ticket can be used.

### CROSS REFERENCE TO RELATED APPLICATIONS

This application claims the benefit of provisional patent application No. 60/528,154, filed Dec. 9, 2003, titled SYSTEMS AND METHODS FOR AUTHORIZING DELIVERY OF INCOMING MESSAGES which is incorporated herein by this reference

### BACKGROUND OF THE INVENTION

1. The Field of the Invention

The present invention relates generally to managing electronic messages. Specifically, the present invention relates to authenticating whether an incoming message addressed to a user has been generated in response to a message sent by the user and delivering the incoming message if it is authenticated.

2. Relevant Technology

Electronic messaging or e-mail has become, for many people, a primary means of communication. The ease by which a person is able to send and receive an electronic message makes this form of communication extremely attractive. Unfortunately, others utilize electronic messaging to send unsolicited bulk electronic messages, better known as “spam.” Unsolicited electronic messages may include commercial advertisements, political messaging, as well as pornographic solicitations. Due to the influx of unsolicited electronic messages, people have become wary of giving out their electronic addresses for fear that their address will be sold to would-be solicitors. Further, those who receive spam are often not able to successfully request removal from mass e-mailing lists. Moreover, it is difficult to ascertain who has sent unsolicited electronic messages, since solicitors often use fabricated addresses or refrain from including one altogether.

Some attempts have been made to allow recipients to filter out unwanted electronic messages. One method includes allowing recipients to block a sender's address by adding the sender's address to a list of unauthorized senders. However, this method falls short because such senders simply have to create different sender's addresses to circumvent the block. In addition, a sender's address can be blocked according to conventional techniques only after the recipient has viewed an electronic message from the sender, determined that it is unsolicited, and manually added the sender's address to the block list.

Other techniques for filtering unwanted electronic messages involve adding certain words or phrases to filtering systems that are integrated into popular electronic messaging software. For instance, a recipient who finds that unsolicited offers for mortgage loans are frequently received can insert the words “mortgage rate” into a filtering component of his electronic messaging program. Subsequent electronic messages that contain the words “mortgage rate” are filtered and placed in a delete or trash folder automatically.

A more successful method for eliminating unsolicited messages uses a challenge/response mechanism. When an electronic message is directed to a recipient, the message is delivered to the recipient only if the sender is identified as being authorized to send electronic messages to the recipient. When the sender is unknown, a challenge message is sent to the sender to verify that the sender's address is valid and that the sender is a person as opposed to a machine. This is confirmed by asking the sender to respond to the challenge message in a way that confirms that the sender is a person as opposed to a machine. This challenge/response method is almost completely successful in eliminating unsolicited electronic messages that are sent by mass-mailers.

However, some forms of spam protection may be overinclusive, meaning that the spam protection actually prevents wanted messages from being sent directly to the user. For example, when a user sends a message to an email address that is no longer active, the recipient server sends a bounce message back to the original sender. A typical bounce message is generated by an automated sender such as postmaster@example.com. . The user generally would like to be made aware of the failure to complete the transmission, yet, due to various forms of spam protection, the user may never receive the bounce message. This is particularly problematic with challenge/response systems, in which the bounce message is challenged and is not delivered unless an appropriate response to the challenge message is made. In this situation, the server that generated the bounce message (e.g., a message from postmaster@example.com) is a machine and cannot respond appropriately to the challenge message. Because no response to the challenge message is made, the bounce message is discarded.

Another similar situation occurs in certain situations involving forwarded messages. Conventional challenge/response systems permit incoming messages to be delivered to a recipient without issuing a challenge message when the incoming message is a reply to an original message. This occurs when the challenge/response server recognizes the sender associated with an incoming message as being the same as the recipient of a previous outgoing message. However, it is common for reply messages to be sent from a second email address that is different from the email address to which the original outgoing message was sent. For example, a user who is protected by a challenge/response system might send an original electronic message to a recipient at fred@workexample.com. If the recipient replies to the original message from another account, such as fred@homeexample.com,: the reply message is placed in a pending folder and a challenge message is sent to fred@homeexample.com.

These problems are not experienced just in challenge/response systems, but occur in any of a variety of filtering systems that use rules to govern the content that is delivered to users. Thus, conventional message filtering systems fail to deliver incoming electronic messages in certain situations in which the incoming messages are desired and do not represent spam. It would be advantageous to provide message filtering systems that are capable of delivering such electronic messages without issuing a challenge message or otherwise failing to deliver the messages.

### BRIEF SUMMARY OF THE INVENTION

The present invention relates to verifying that an incoming electronic message has been generated in response to a previous outgoing message. These methods are generally applicable in a variety of message filtering systems that have rules that determine whether to deliver incoming electronic messages to a user computer. Challenge/response electronic messaging systems represent an example of the message filtering systems with embodiments of the invention can be used. In this context, the methods for validating incoming electronic messages can be used to authorize delivery without issuing a challenge message. This allows incoming messages that are received in response to previous outgoing messages to be reliably delivered to the user.

In summary, an outgoing message is tagged with a delivery ticket or marker so that incoming messages that contain or reference that delivery ticket in the proper manner are delivered to the inbox of the user who generated the original outgoing message without requiring a challenge message. The authenticated incoming message thus avoids challenges or other spam filtering mechanisms that might otherwise prevent the incoming message from being sent directly to the user. In general, these methods can be used in combination with substantially any filtering system that uses rules to govern the electronic message content that is delivered to users.

In one embodiment, a computer networked system is provided in which a user computer communicates with an authentication server. The authentication server contains a processor that includes an email program, a delivery ticket generator, and, an authentication module, and a data storage medium that includes a user inbox, a pending folder and a delivery ticket database.

When the user generates an outgoing message, the authentication server inserts a delivery ticket into the outgoing message. The delivery ticket may be inserted in the envelope and/or content portion of the outgoing message. The outgoing message is then delivered to a recipient server. The recipient server may be the intended server or may be a server to which the outgoing message is forwarded. The delivery tickets are useful for authentication when the recipient server generates a reply message that is sent to the authentication server and: includes the delivery ticket.

The delivery ticket is a unique string which acts as a marker on outgoing messages. In one embodiment, the delivery ticket includes a user identifier, a version indicator, a time stamp, a uniquifier, a checksum, and the domain identifier. In other embodiments, the delivery ticket may contain a different data structure, for example, by using other cryptographic, authentication or digital signature methods.

When an incoming message, such as a reply message described above, is received with what appears to be a delivery ticket, the authentication server verifies that the delivery ticket is valid. In one embodiment, authentication includes recomputing the checksum using the same algorithm and private key and comparing it to the one that is contained in the delivery ticket of the incoming message to determine if they are the same. The delivery ticket may also be configured for certain uses, such as single-use, multiple-use, or time-based usage.

A delivery ticket database located at the authentication server is used to validate single-use or multiple-use delivery tickets. When a single-use or multiple-use delivery ticket is first received in an incoming electronic message and validated, an entry associated with the delivery ticket is added to the delivery ticket database. The entries of the database indicate whether the permitted number of uses of a particular single-use or multiple-use delivery ticket has been reached. Specific delivery tickets that accompany outgoing electronic messages generally do not need to be included or tracked in the database until they have been found in incoming electronic messages.

The validity of a time-based usage delivery ticket can be validated by determining whether the time period associated with the delivery ticket has expired. If the time period has expired the delivery ticket is invalid. If the time period has not yet expired, the delivery ticket database can be used to determine whether the delivery ticket has been specifically flagged as being invalid, which can occur, for instance, if a user or administrator determines that a particular time-based delivery ticket has been compromised during the period of time during which it would otherwise be valid.

The delivery ticket mechanism is particularly useful in situations in which the sender associated with an incoming message is not recognized by a challenge/response system as being an authorized sender, even though the incoming message represents a reply message to an original outgoing electronic message. In a first example, the incoming message is a bounce message generated when an original outgoing message from a user protected by a challenge/response system is sent to an inactive address. The bounce message would be challenged in conventional challenge/response systems. However, using the methods disclosed herein, if the bounce message contains a valid delivery ticket, the bounce message is delivered to the user without a challenge message.

In a second example, the incoming message is a reply to an original outgoing message from a user protected by a challenge response system. In this example, the party replying to the original message does so using another account that is different from the account to which the original message has been sent. Because the account from which the incoming reply message has been sent is not recognized as being authorized by conventional challenge/response systems, the incoming reply message would ordinarily result in a challenge message. However, using the methods disclosed herein, if the incoming reply message includes a valid delivery ticket, the incoming reply message is delivered to the user without a challenge message.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary network environment and system for implementing features of the present invention;

FIG. 2a illustrates a message exchange that results in a bounce message having a delivery ticket.

FIG. 2b illustrates a message exchange that results in a reply message that is sent from a second server and has a delivery ticket.

FIG. 3 illustrates one embodiment of the data structure of an outgoing message; and

FIGS. 4a and 4b illustrates one embodiment of the data structure of a configuration file and a delivery ticket database.

### DETAILED DESCRIPTION OF THE PREFERRED EMBODIMENTS

The present invention relates to challenge/response electronic messaging systems and methods of determining whether an incoming message has been generated in response to a user's outgoing message. Furthermore, the present invention relates to authorizing delivery of such authenticated incoming message without issuing a challenge message. This allows incoming messages that are received in response to previous outgoing messages to be reliably delivered to the user.

In summary, an outgoing message is tagged with a delivery ticket or marker so that incoming messages that contain or reference that delivery ticket in the proper manner are delivered to the inbox of the user who generated the original outgoing message without requiring a challenge message. This way, the authenticated incoming message avoids challenges or other spam filtering mechanisms that might otherwise prevent the incoming message from being sent directly to the user.

1. Computer Environment and Data Structure of Delivery Ticket

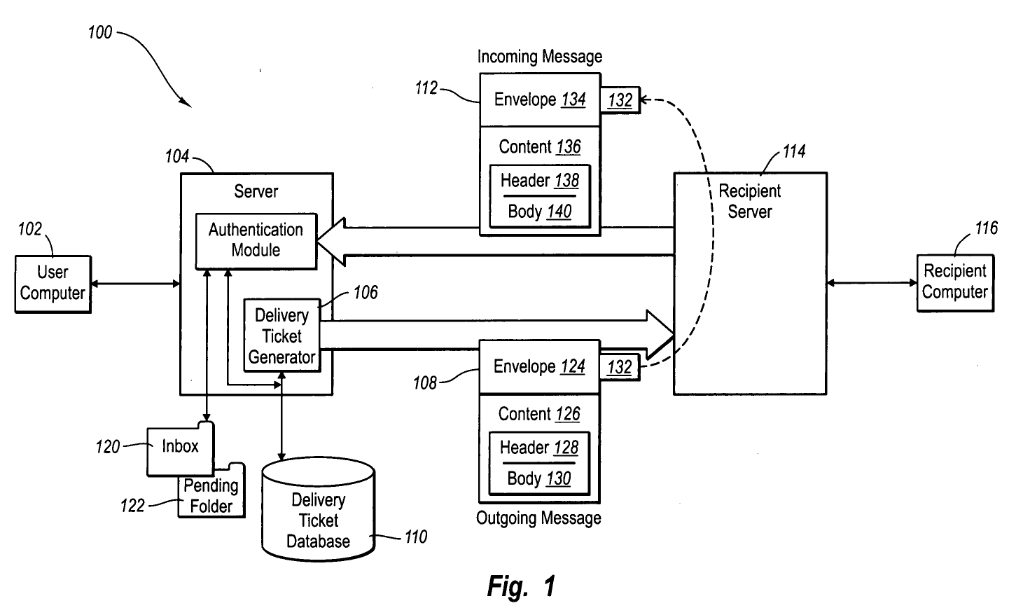

Turning to FIG. 1, an exemplary network system 100 is illustrated. A client device or user computer 102 is in communication with an authentication server 104. The authentication server 104 provides electronic messaging services for the user computer 102 and uses a filtering system having rules that determine whether to deliver incoming electronic messages to the user computer 102. Although the methods disclosed herein can be used generally with any of a variety of systems that filter electronic messages, the following example will be described in the context of a challenge/response system. Challenge/response systems use challenge messages to determine whether an entity that has sent an incoming message is a person as opposed to a machine by requiring the sending entity to perform a specified task that a machine is unlikely to be capable of performing. Examples of suitable challenge/response systems that can be adapted for use with the methods disclosed herein are described in U.S. patent application Ser. No. 10/174,561, filed Jun. 18, 2002 and U.S. Pat. No. 6,199,102, issued Mar. 6, 2001, both of which are incorporated herein by reference.

When a user creates an electronic message and initiates transmission thereof, the electronic message is processed by delivery ticket generator 106 of server 104. The delivery ticket is incorporated into the electronic message, which is then sent as outgoing message 108 to the recipient. The processor of server 104 can also include an email program that, in addition to implementing the delivery tickets and the associated methods of authenticating incoming messages, also processes electronic messages and performs operations such as receiving, deleting, and forwarding messages. In general, the methods disclosed herein for using delivery tickets can be implemented in this and other electronic messaging systems, including those in which many of the operations are performed at the user computer 102 rather than at server 104. The operations performed by server 104 can also be distributed among multiple servers or computer systems.

The delivery tickets are used when an outgoing message is sent to a recipient. As shown in FIG. 1, an example of the transmission of an outgoing message with a delivery ticket to a recipient can be implemented in a system that includes a recipient server 114 associated with a recipient computer 116. When the recipient (i.e., either the recipient computer 116 or the recipient server 114) generates a reply message, the reply message incorporates the delivery ticket and is sent as incoming message 112 to the user. Details of the structure of the delivery tickets and the manner in which they are incorporated into outgoing message 108 and incoming message 112 are described hereinbelow. The incoming message 112 is “incoming” from the standpoint of the user of user computer 102. Similarly, the outgoing message 108 from the standpoint of the user, and is also referred to herein as an “original” message.

As will be described in greater detail below, an authentication module 118 of server 104 processes incoming message 112 by determining whether the incoming message includes a valid delivery ticket, which indicates whether the delivery ticket has previously been included in an outgoing message. This operation is performed to determine whether the incoming message 112 has been generated as a reply to the outgoing message 108. If the valid delivery ticket is included in the incoming message 112, the server 104 places the incoming message in an inbox 120, in effect delivering the incoming message to the user.

If no valid delivery ticket is included in the incoming message 112 and if message filtering system, such as the challenge/response system, employed by server 104 determines that there is no other reason for delivering the incoming message, the incoming message is either discarded or placed in pending folder 122. Depending on the nature of the filtering system, a challenge message may then be sent to the entity that purports to have sent the incoming message 112 while the incoming message is stored in the pending folder 122 according to conventional challenge/response techniques.

As noted above, a user sends an electronic message 108 (hereinafter referred to as the “outgoing message”), which is generated at the server 104. FIG. 1 further illustrates the structure of outgoing message 108 and incoming message 112. Outgoing message 108 includes an envelope 124 and content 126. The content includes a header 128 and a body 130. Outgoing message 108 is further processed at the authentication server 104. The authentication server 104 adds a delivery ticket 132 onto the electronic message.

The incoming message 112 also includes an envelope 134 and content or data 136. The content further includes a header 138 and a body 140. The content 136 may or may not include portions of the header 128 or body 130 of the outgoing message 108. When the incoming message 112 is generated based on an outgoing message 108 containing a delivery ticket 132, the delivery ticket 132 is transferred or included in the incoming message 112.

2. Bounce Messages and Reply Messages from Secondary Accounts

Generally, when an outgoing message 108 is sent to the correct destination and can be successfully delivered to the recipient's inbox without any reply being required or generated, the delivery ticket 104 remains unused. However, whenever a reply is generated based on the original message, the reply message automatically incorporates the delivery ticket.

When the outgoing message is successfully delivered to the recipient computer and replied thereto, such that the incoming message is addressed from the account to which the outgoing message was originally intended, the challenge/response system of the server 104 recognizes the sender of the reply message as being authorized and causes the reply message to be delivered to the inbox. Such reply messages include the delivery ticket, which is not processed by server 104 because the reply message is already authenticated.

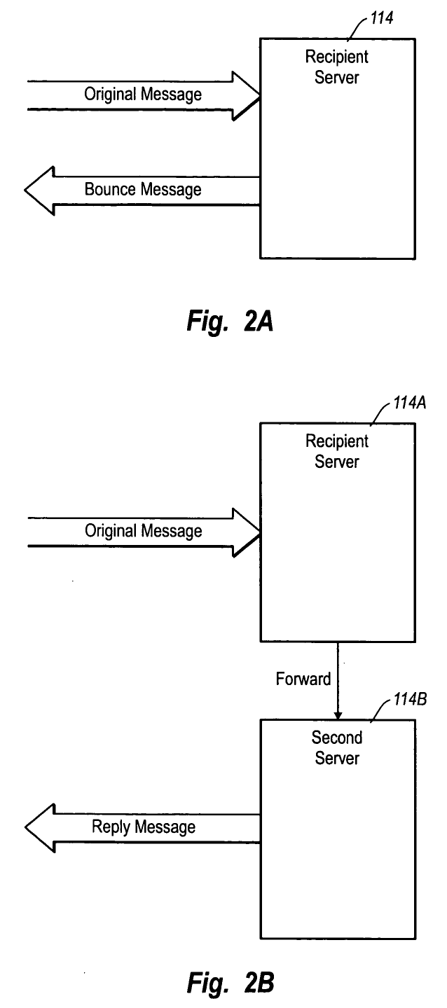

The delivery ticket is used by the server 104 to authenticate only when the challenge/response system does not recognize the sender of the incoming message. Examples of this are illustrated in FIGS. 2a and 2b, in which the reply message is addressed from a sender that is different than the address to which the original message was intended. In these situations, the challenge/response system of the server 104 in the absence of a delivery ticket would generally be unable to successfully deliver such reply message to the user's inbox without first undergoing a challenge/response sequence. The delivery ticket provides a means for recognizing that the incoming messages in these and other situations have been generated in response to original messages generated by the user. In these situations, the delivery ticket is useful for verifying whether the incoming message 112 resulting from the action should be sent to the user's inbox or whether it should be considered as an unauthorized message without having to use a challenge/response mechanism.

FIG. 2a illustrates a first example of a messaging sequence that would ordinarily result in the failure to deliver an incoming message to a user when performed using conventional challenge/response systems or other filtering systems. As illustrated therein, an original message is drafted by the user and intended to be transmitted to a recipient address (e.g., recipient@example.com). However, in this example, the recipient account is unable to receive the original message for one of various reasons—e.g., the account is deactivated, the account is invalid, etc. Thus, the recipient server 114 associated with the recipient computer “bounces” the message back to the server 104 with a message that the original message was unable to be properly delivered. The bounce message created by the recipient server 114 may thus have in its envelope 134 a “From:” address such as postmaster@example.com. The “Envelope From” field is null for bounced messages, by e-mail convention so that bounced messages cannot in turn be bounced.

Since the “From:” address of the bounce message is different than the one to which the original message was originally intended, the challenge/response system in the server 104 would ordinarily generate a challenge to this unknown address if not for the methods disclosed herein for using a delivery ticket to enable delivery of the bound message. If a challenge message were to be created, the challenge message would be sent to the recipient server 114, which would not be capable of responding thereto. Thus, in the absence of a delivery ticket, the bounce message would normally be classified as a message to be filtered and sent to the pending folder 122 or discarded completely without the user being aware of the existence of the bounce message.

However, according to the methods disclosed herein, the original message contains a delivery ticket. The bounce message includes a copy of the valid delivery ticket. When the authentication server 104 receives the bounce message, it identifies the delivery ticket, determines whether the delivery ticket is authentic, and then causes the bounce message to be delivered without sending a challenge message back to the postmaster or otherwise filtering out the bounce message.

FIG. 2b illustrates a second messaging sequence that often results in the failure to deliver an incoming message. In this example, an original message is sent to the recipient server 114A and is forwarded to a second server 114B. For example, server 114A may be the recipient's work address while the second server 114B might be the recipient's home address. The recipient is able to read the original message at server 114B and, in this example, generates a reply message to the original message. However, when using conventional challenge/response systems, the identity of the sender of the reply message from the second server is not recognized, even though the reply message has been sent in response to the original message. A conventional challenge/response system would send a challenge message back to the sender of the reply message. Although the sender of the reply message can respond appropriately to the challenge message, this is undesirable since, from the standpoint of the sender of the reply message, the sender is merely replying to the original message.

Thus, according to methods disclosed herein, the original message includes a delivery ticket. The forwarded message also includes the delivery ticket. In addition, the reply message generated from the forwarded message incorporates the delivery ticket. Thus, when the reply message is received by the authentication server 104, the delivery ticket is identified, authenticated, and the reply message allowed to be delivered directly to the user's inbox without creating a challenge message or otherwise filtering or failing to deliver the reply message.

3. Structure of Delivery Tickets

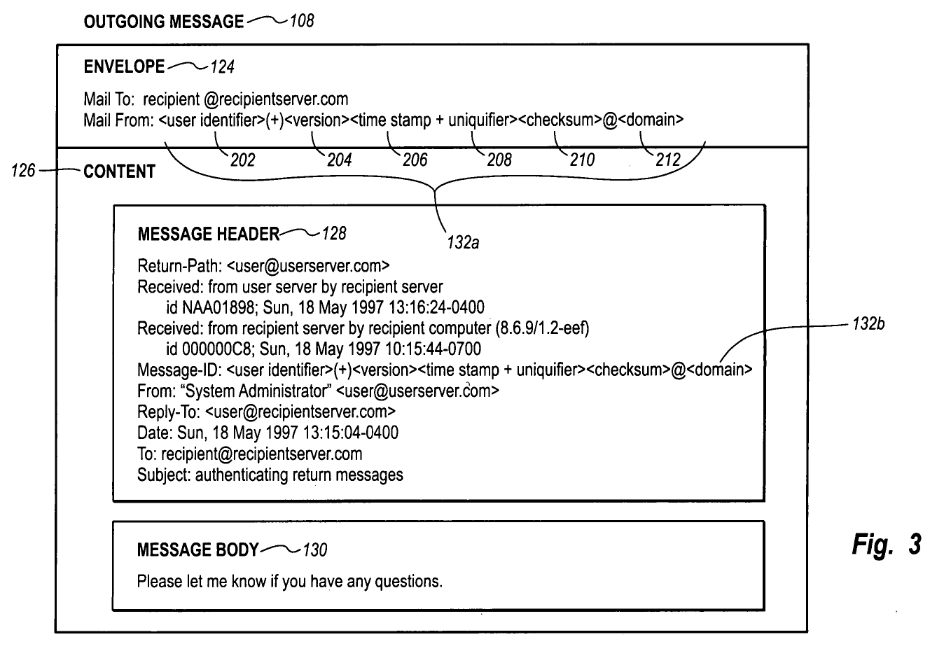

With reference to FIG. 3, an exemplary data structure of an outgoing message 108 is shown after it has been processed by authentication server 104. As shown in FIGS. 1 and 3, the outgoing message 108 includes envelope 124 and content 126. The content includes a header 128 and a body 130.

The envelope 124 contains “envelope sender” and “envelope receiver” fields. The server 104 automatically creates the envelope using the information provided in the “To:” and “From:” header fields in header 128. In the case where the message is forwarded, at each Simple Mail Transfer Protocol (SMTP) hop, the “envelope sender” field will be carried with the outgoing message 108. In addition to the “To:” and “From:” fields, header 128 also contains other fields such as “Subject:”, “Cc:”, and “Date:”. The message body 130 consists of everything else in the content 126. The message may contain text or other multimedia attachment.

The delivery ticket 132 is generated by authentication module 118 of authentication server 104. The delivery ticket 132 is generally a unique string which acts as a marker on outgoing messages. The marker is transferred to incoming messages that are generated in response to the outgoing message so that the marker can be identified by the authentication server 104 as relating to an original outgoing message. The delivery ticket 132 may have a variety of features in order to create a unique string.

As shown in FIG. 3, a delivery ticket 132a is appended to or embedded in the envelope 124 of outgoing message 108. The following discussion relates to a specific example of a delivery ticket 132a and the various fields that are contained by the delivery ticket. The following example represents only one way of implementing the delivery tickets and any of a variety of other techniques can be used. In this example, the delivery ticket 132a includes a user identifier 202, a version indicator 204, a time stamp 206, a uniquifier 208, a checksum 210, and the domain identifier 212. The user identifier 204 can be derived from the user's email address, e.g., using the user's username. Generally, the user identifier 204 has a 32 character maximum. The version 204 is typically a one character version indicator that indicates the version of the delivery ticket. The time stamp 206 indicates the time that the delivery ticket was generated and can be based on the authentication server's 112 geographic location. The uniquifier 208 is typically an unsigned integer that is unique for each delivery ticket generated on a particular authentication server 104 in the same second. In one embodiment, the time stamp 206 and uniquifier 208 are generated using an 11 character base64 encoding of the time stamp and uniquifier.

The checksum 210 is a number that has been computed from the clear text portions of the delivery ticket and a private key, or salt, and is used to authenticate the corresponding incoming message. In one embodiment, the checksum is computed using an algorithm and the private key and then sent with the outgoing message. The algorithm may be any suitable encryption/signature algorithm, for example, the md5 algorithm. In another embodiment, the md5 algorithm may be used in combination with a private salt value. When a future incoming message is received with what appears to be a delivery ticket 132a, the authentication server 104 recomputes the checksum using the same algorithm and secret key and compares it to the checksum that is contained in the delivery ticket 132a of the incoming message. If they are the same, the incoming message is assumed to be an authentic reply to a previous outgoing message because the entity that generated the incoming message had access to the delivery ticket and included it in the incoming message.

The delivery ticket is placed in an appropriate field that will cause it to be included in bounce messages or reply messages that might later be generated in response to the outgoing electronic message. To accommodate future bounce messages, the delivery ticket is placed in the envelope of the outgoing message, either in the “Envelope From:” field or in the “Mail From:” field. When an SMTP server generates a bounce message, the bounce message is addressed using information in the “Envelope From:” or “Mail From:” fields. Thus, when the delivery tickets described herein are included in these fields, bounces generated in response to outgoing messages include the delivery tickets. The delivery ticket can also be placed in the “Reply To:” header or in the “References” header of the outgoing message to permit replies to outgoing message to be recognized as being valid. Most mailers obtain address information for reply messages either from the “Reply To” header or the “References” header of the message. In order to handle both incoming bounce messages and incoming reply messages, the delivery ticket is placed in both the envelope fields and the message headers as described above. As such, FIG. 3 shows a second delivery ticket 132b placed in the content 126 of outgoing message 108. Specifically, the delivery ticket 132b is located in message header 128 in the “Reply To:” field. The implementation of a delivery ticket in the content portion of outgoing message 108 will be described below in further detail.

While delivery tickets generally do not ensure that the sender of an incoming message is identical to or has a relationship of trust with the recipient of a previous outgoing message sent by the user, the delivery ticket nonetheless can be used to confirm that the incoming message has been generated by a sender who has had access to a previous outgoing electronic message sent by the user. Delivery tickets are generally valid only for a specified period of time or for a single or limited number of uses. There may be unusual cases in which a person who accesses a valid delivery ticket included in an outgoing message sent by the user succeeds in misusing the delivery ticket. However, this misuse is limited in time or in the number of electronic messages that can be sent. Moreover, someone who has access to a valid delivery ticket and might misuse it would also generally have access to a valid “To:” and “From:” address pair that can be used to successfully send unwanted messages to the user (i.e., the party identified by the “From:” address) in an unlimited manner. In other words, the use of a delivery ticket does not compromise message security and is useful in permitting certain desirable messages to be successfully delivered as described herein.

After the creation of the checksum and the placement of the delivery ticket 132 in the appropriate fields and headers as described above, the message is transmitted by the SMTP server system. Authentication server 104 and/or recipient server 114 may be configured to operate as SMTP servers. At this point, a copy of the delivery ticket 132 is not stored on the authentication server 104, because the server is capable of recognizing valid delivery tickets by regenerating the checksum during the verification process.

It will be appreciated that the delivery ticket 132 may contain a different data structure by using other cryptographic, authentication or digital signature methods. For example, a segment of random text can be added to the checksum, which would further ensure that the checksum is unique and irreproducible. As discussed above, the delivery ticket 132 can be embedded in any part of the outgoing message, as will be discussed in the “reply from a different address” example below. For example, a header in message header 128 may be configured by authentication server 104 to include a delivery ticket 132. However, the envelope 124 is one preferred method of attaching a delivery ticket 132 because the information in the envelope is consistently used by most email servers in order to generate bounce messages based on the outgoing message containing the delivery ticket.

4. Authenticating User-Generated Response

The process of authenticating an incoming message will now be discussed in further detail. When a recipient server 114 sends an incoming message 112 that is based from or in reply to an outgoing message 108, the incoming message is generated using information contained in the outgoing message. In one embodiment, the delivery ticket 132 is located in the envelope 124 of the outgoing message 108 in the “Mail From:” field. The recipient server 114 uses the information from envelope 124 of outgoing message 108 to create the incoming envelope 134 of the incoming message. The recipient server 114 uses the information in the “Mail From:” field of the envelope 124 of the outgoing message 108 to create the “Mail To:” field in the incoming envelope 134 of the incoming message 112. Thus, the incoming message 112 contains delivery ticket 132 in the incoming envelope 134, which delivery ticket is recognized and authenticated at the authentication server 104. Note that the incoming message 112 may or may not include information from the content 126 of outgoing message 108.

Since the incoming message 112 is being sent back to the user, the incoming message 112 is delivered to authentication server 104. The authentication module 118 at the authentication server 104 analyzes the incoming message 112 to determine whether or not it is an authorized message. First, the authentication module 118 determines if incoming message 112 contains a delivery ticket 132 somewhere embedded therein. Second, the authentication module 118 authenticates the delivery ticket. Using a private key, the authentication module 118 regenerates the checksum and verifies that the regenerated checksum is the same as the checksum in the delivery ticket 132. If the checksum in the delivery ticket 132 is the same as the regenerated checksum, this indicates that the delivery ticket is authentic, i.e., was generated by the authentication server 104. Third, an action is then authorized based on this authentication. However, completion of the action may depend on other factors, as will be explained below.

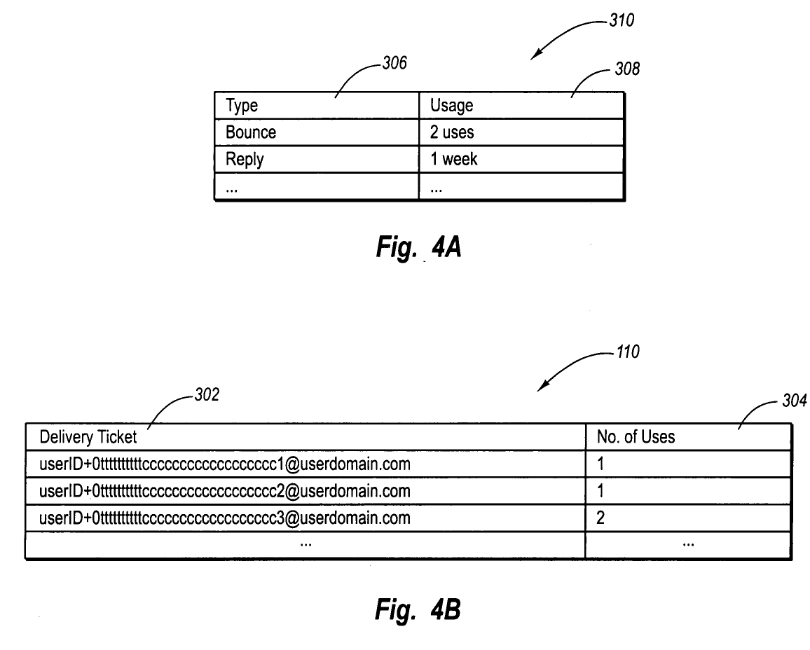

As shown in FIG. 4a, server 104 contains a configuration file 310 that defines and tracks how a particular type of delivery ticket may be used. For example, a specified type of delivery ticket may be generated based on a single-use, multiple-use, or timed-use basis. In this embodiment, the validity of incoming delivery tickets can be determined by examining the delivery ticket itself and, in some cases, referring to configuration file 310 to determine how the particular type of delivery ticket is to be validated. Two basic types of delivery tickets are those that are used for bounce messages and those that are used for reply messages, although the delivery tickets described herein can be used for other purposes and can have correspondingly different types.

For each of the delivery ticket types, the configuration file 310 can define the number of times a valid delivery ticket can be used or, in other words, whether valid delivery tickets of the specified type are single-use or multiple-use. Defining delivery ticket types in this manner eliminates the need to separately define this information in the configuration file 310 or database 110 for individual delivery tickets. The type of a particular delivery ticket can be inferred from directly examining the delivery ticket. The validity of delivery tickets that are valid only for a specified period of time can be determined by directly examining the content of the delivery tickets without referencing the database to obtain this information. Any of a variety of data structures that contain the necessary information can be used as configuration file 310, and the term “configuration file” as used herein extends to any such suitable data structure.

An example of a delivery ticket database 110 is also shown in FIG. 4b. The delivery ticket database 110 is populated or updated when a single-use or multiple-use delivery ticket is received in an incoming electronic message. The delivery ticket database can also be updated when a user or administrator determines that a particular delivery ticket has been misused or compromised. Delivery ticket database 110 contains a field 302 for identifying individual delivery tickets and a field 304 that has a counter tracking the number of times the particular delivery ticket has been used. Any of a variety of data structures containing the necessary information can be used, and any such data structure is referred to herein as a delivery ticket “database.”

When an incoming message that is to be filtered or analyzed using a delivery ticket is received, the initial step for validating the delivery ticket involves regenerating the checksum as described herein. If the checksum is successfully regenerated, the type of the delivery ticket is inferred and, based on the information stored in the configuration file 310, the rules to be applied to delivery tickets of the specified type are identified. If the delivery ticket is valid for a specified period of time, the delivery ticket is examined directly to determine whether the delivery ticket is on its face valid. If the time has expired, the delivery ticket is declared invalid and the incoming message is processed accordingly. If the time has not yet expired, the delivery ticket database 110 is accessed to determine whether the particular delivery ticket has been specifically disabled. If the delivery ticket is not specifically disabled, the delivery ticket is declared to be valid and the associated incoming electronic message is delivered or otherwise processed. One example of the specific disablement of a delivery ticket could occur when it has been determined that a delivery ticket having a duration of one week has been compromised. In response to this determination, a user or an administrator can specifically disable the delivery ticket to avoid a week-long security hole. One benefit of time-based delivery tickets is that database entries for incoming delivery tickets do not need to be maintained.

If the delivery ticket is valid for a single use or multiple uses, the delivery ticket database 110 is accessed to determine whether the specified number of uses has already been made. If the database 110 indicates that the specified number of uses has already been made, the delivery ticket is declared invalid and the associated incoming electronic message is processed accordingly. If the specified number of uses has not already been made, the delivery ticket is declared to be valid and the associated incoming electronic message is delivered or otherwise processed. In this case, an entry in database 110 is either created or an existing entry is updated to show the number of times that the delivery ticket has now been used.

Another option is for certain delivery ticket types to be valid under conditions that combine use-based rules and time-based rules. For example, a delivery ticket can be valid for a single use and for a certain amount of time, meaning that if either condition fails, the delivery ticket is invalid. In this case, the delivery ticket database 110 does not need to store the delivery ticket information for an extended period of time.

When delivery tickets for bounce messages and reply messages are both used, the private keys applied to the two delivery tickets are different. This prevents a bounce delivery ticket from being included in another type of message, such as a reply message. Similarly, this prevents a reply delivery ticket from being used to generate a bounce message. When an incoming message with a delivery ticket is received, the context of the delivery ticket indicates which of the two private keys is to be used to regenerate the checksum.

In general, when an incoming message with a delivery ticket is received and the delivery ticket is to be used to authenticate the incoming message, the delivery ticket is processed to determine whether it is valid. As used herein, a “valid” delivery ticket is one that has a valid checksum and, according to specified rules, the delivery ticket has not been invalidated.

While the foregoing embodiments have been described in the context of a configuration file that defines the usage rules for types of delivery tickets, embodiments of the invention can also be implemented using more detailed delivery ticket databases. For example, the delivery ticket database can include information for all delivery tickets that have been received, including those that are time-based. The delivery ticket database can include information that defines the type of the delivery ticket or the rules that apply thereto, such as the number of uses for which the delivery ticket is valid. In general, however, such implementations are more complex and can be less efficient than the embodiments described above in reference to FIGS. 4a and 4b.

### EXAMPLE 1

### Bounce Messages

A first example of a situation in which the delivery tickets are useful is in the case of a “bounce” message of FIG. 2a. At the server, the outgoing message is generated having a delivery ticket in the envelope. In one embodiment, the delivery ticket is in the “envelope sender” field of the envelope. At the recipient server, if the outgoing message can be successfully delivered to the recipient's inbox, then the delivery ticket information is not used. However, in some cases, the recipient server will be unable to successfully deliver the outgoing message. For example, the recipient's email address may no longer be active, the recipient's inbox may be full, etc. In these cases, the recipient server “bounces” the message back to the address located in the “envelope sender” field. That is, the recipient server generates an incoming bounce message and in the envelope, the “envelope receiver” field contains the delivery ticket (which was formerly in the “envelope sender” field of the incoming message). The incoming message is analyzed at the authentication server as discussed above. If the delivery ticket is authenticated and complies with any usage requirements, the incoming message is delivered directly to the user's inbox.

The usefulness of the delivery ticket is illustrated in the example where the user has an “accepted addresses” list which is used to filter out unwanted messages. An accepted addresses list contains a list of authorized email addresses which are allowed to send messages directly to the user's inbox. A reply message from the recipient without a bounce would normally have the recipient's email address (e.g., recipient@example.com), which would allow direct access to the user' inbox. However, the incoming bounce message does not include the recipient's authorized email address. Instead, it includes an email address identifying the recipient's server (e.g., postmaster@example.com), which is likely not on the user's accepted addresses list. Thus, messages coming from the recipient server would normally be considered unauthorized. However, it would be in the user's interest to be notified that a recipient's email address is invalid or that the recipient's inbox is full. The inclusion of the valid delivery ticket in the incoming bounce message permits the message to be sent to the user's inbox.

In this embodiment, where the incoming message envelope “Mail To:” field simply reflects the outgoing message envelope “Mail From:” field, authorization of the incoming message does not depend on the content of the incoming message, primarily because the bounce may not include the original message or may include just a portion thereof.

### EXAMPLE 2

### Reply from a Different Address

In some cases, as illustrated in FIG. 2b, a message created by the user is sent to the recipient server, but forwarded to a different location where the recipient reads the message and, in some cases, responds to it. For purposes of this example, the incoming message will be referred to as the reply message. The reply message containing an address from the forwarded server will likely not be on the user's accepted addresses list and be rejected as unauthorized, even though it was created in response to an action by the user. Thus, in order to recognize that the reply message is in response to an action by the user, (even though it may have a different address), a delivery ticket is used to allow the reply message to be sent directly to the user's inbox.

In the message header of the outgoing message, a delivery ticket is embedded in the “message ID” field or in the “Mail From:” field. Most email programs, when generating a reply message, generate the header of the reply message by including or referencing the message I.D. of the outgoing message. The header of the reply message generally contains a “Reply To:” field or a “References:” field. The “References:” header indicates a history of a chain of messages, while the “Reply To:” field indicates the information from the most recent message. Thus, when the reply message is generated, the “Reply To:” field or “References:” field will contain the delivery ticket. The authentication server can be configured to search only the most recent header of the reply message, to search all headers of the reply message, to authenticate the delivery ticket only if it is located in a certain header in a chain of headers of the reply message, and the like. After the delivery ticket is authenticated, the reply message is allowed to be sent directly into the user's inbox if it complies with usage requirements.

### EXAMPLE 3

### Challenge/Response Protocols

In another example, the delivery ticket concept can be applied to messaging systems in which the recipient of an original electronic message uses a challenge/response protocol. In one embodiment, the user of user computer 102 of FIG. 1 sends an outgoing message 108 having a delivery ticket to the recipient. The recipient server 114 implements a challenge/response system that generates a challenge message (i.e., incoming message 112 of FIG. 1) in response to outgoing message 108. In conventional challenge/response systems, the challenge message issued by the recipient may never make it to the user's inbox, allowing the user to make a response, because it is sent from a different address (e.g., challenge@example.com), which is not recognized by the authentication server 104. Thus, the user's outgoing message may never be delivered to the recipient because the user does not have an opportunity to respond to the challenge issues by the recipient.

If the user associated with user computer 102 and server 104 also uses a challenge/response system, the incoming challenge message 112 may itself result in another challenge message generated at the user end. In effect, the challenge/response systems of the two servers engaged in the electronic messaging may set off what can be described as a “challenge war”, in which a series of challenge messages are exchanged between servers without the challenge messages being delivered to the respective inboxes.

However, because the incoming challenge message 112 includes a delivery ticket, server 104 can detect the valid delivery ticket and determine that the incoming challenge message 112 is to be delivered to inbox 120, allowing the user the opportunity to respond to the challenge so that their original message can be successfully delivered.

The above examples show that the process can be tailored for different purposes. For example, the delivery ticket can be attached to different parts of the incoming message to differentiate the incoming message. That is, for bounce messages, the delivery ticket is located in the envelope, while for reply messages, the delivery ticket is part of the header in the message content. In addition, a different salt or private key value is used with each of the two delivery ticket types so that one delivery ticket cannot be substituted by another. In this way, a hacking system cannot use the delivery ticket from the envelope of one message and place it in the content of another message.

Furthermore, the process can allow for multiple types of incoming messages in response to an outgoing message. For example, when a user sends a message, there is an equally likely chance that the message may bounce or be replied to. It is possible to place a different delivery ticket in both the envelope and the content of the outgoing message to account for the possibility that the message could bounce or be replied to.

In addition, the process can be tailored so that certain actions are taken after the delivery ticket is authenticated. As described above, authentication of a delivery ticket may allow the incoming message to be sent to the user' inbox. In another example, authentication of a delivery ticket for a reply message could place the recipient's email address on the user's accepted addresses list.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In an authentication server included in an electronic messaging system, wherein a user sends an outgoing message and receives incoming messages, a method of authenticating an incoming message comprising:
receiving an incoming message;
analyzing the incoming message to identify whether the incoming message contains a delivery ticket that includes data and a checksum; and
if the incoming message includes a delivery ticket, determining whether the delivery ticket is valid to authenticate the incoming message.

2. The method as recited in claim 1, further comprising delivering the incoming message to the user's inbox if it is determined that the delivery ticket is valid.

3. The method as recited in claim 1, further comprising referencing a database to determine the use of the delivery ticket.

4. The method as recited in claim 3, wherein the use of the delivery ticket is defined as at least one of single-based, multiple-based, and time-based usage.

5. The method as recited in claim 4, further comprising delivering the incoming message to the user's inbox if the delivery ticket complies with the defined use.

6. The method as recited in claim 1, further comprising sending the incoming message to a pending file if it is determined that the delivery ticket is not valid.

7. The method as recited in claim 1, wherein determining whether the delivery ticket is valid comprises regenerating the checksum to determine whether the regenerated checksum is the same as the checksum included in the delivery ticket.

8. In an authentication server in an electronic messaging system, wherein a user sends an outgoing message and receives incoming messages, a method of authenticating an incoming message comprising:
inserting a first delivery ticket into an outgoing message;
receiving an incoming message;
analyzing the incoming message to identify whether the incoming message contains a second delivery ticket;
if the incoming message includes a second delivery ticket, determining whether the second delivery ticket is valid to authenticate the incoming message; and
if the second delivery ticket is valid, delivering the incoming message to the user's inbox.

9. The method as recited in claim 8, wherein the delivery ticket comprises a checksum.

10. The method as recited in claim 8, wherein inserting the delivery ticket into the outgoing message comprises inserting the delivery ticket into the envelope portion of the outgoing message.

11. The method as recited in claim 8, wherein inserting the delivery ticket into the outgoing message comprises inserting the delivery ticket into the content portion of the outgoing message.

12. The method as recited in claim 8, further comprising referencing a database to determine the use of the delivery ticket.

13. The method as recited in claim 12, wherein the use of the delivery ticket is defined as at least one of single-based, multiple-based, and time-based usage.

14. The method as recited in claim 13, further comprising delivering the incoming message to the user's inbox if the delivery ticket complies with the defined use.

15. The method as recited in claim 8, wherein:
the outgoing message is intended for a particular recipient account;
the incoming message is generated from an account that is different from the recipient account; and
the first delivery ticket is the same as the second delivery ticket.

16. The method as recited in claim 15, wherein the account that is different from the recipient account is located on a server that is in communication with the recipient account.

17. The method as recited in claim 15, wherein account that is different from the recipient account is a server to which the outgoing message was forwarded.

18. The method as recited in claim 8, wherein the outgoing message is intended for a particular recipient account and the incoming message is a challenge message generated by a challenge/response system associated with the recipient account.

19. In an electronic messaging system, in which a user sends an outgoing message and receives incoming messages, a method of authenticating an incoming bounce message comprising:
receiving an incoming bounce message that has been generated by a remote server in response to the remote server receiving an electronic message that has been sent by a user and is addressed to a recipient account that is unavailable;
determining whether the incoming bounce message contains a delivery ticket, wherein, if the incoming bounce message contains the delivery ticket, the delivery ticket includes data and a checksum;
if the incoming bounce message includes the delivery ticket, determining whether the delivery ticket is valid by regenerating the checksum, including:
applying a private key value to data; and
determining whether the regenerated checksum is the same as the checksum included in the delivery ticket; and
if it is determined that the delivery ticket is valid, delivering the incoming bounce message to the user's inbox.

20. The method as recited in claim 19, wherein the delivery ticket is contained by the incoming bounce message and has been placed in the incoming bounce message by the remote server when the remote server generated the incoming bounce message.

21. The method as recited in claim 20, further comprising, prior to receiving the incoming bounce message, sending the electronic message that is addressed to the recipient account, the electronic message containing the delivery ticket.

22. The method as recited in claim 21, wherein the delivery ticket is included in a field in an envelope of the electronic message.

23. The method as recited in claim 19, further comprising, if it is determined that the incoming bounce message does not include the delivery ticket, not delivering the incoming bounce message to the user's inbox.

24. The method as recited in claim 19, further comprising, if it is determined that the delivery ticket is not valid, not delivering the incoming message to the user's inbox.

25. The method as recited in claim 19, wherein determining if the delivery ticket is valid comprises:
identifying a usage rule associated with the delivery ticket; and
determining whether the delivery ticket complies with the usage rule.

26. The method as recited in claim 25, wherein the usage rule associated with the delivery ticket is at least one of a single-use rule, a multiple-use rule, and a time-based rule.

27. In an electronic messaging system, in which a user sends an outgoing message and receives incoming messages, a method of authenticating an incoming message comprising:
receiving an incoming reply message that has been generated by a remote computer in response to an electronic message that has been sent by a user;
determining whether the incoming reply message contains a delivery ticket, wherein, if the incoming reply message contains the delivery ticket, the delivery ticket includes data and a checksum;
if the incoming reply message includes the delivery ticket, determining whether the delivery ticket is valid by regenerating the checksum, including:
applying a private key value to data; and
determining whether the regenerated checksum is the same as the checksum included in the delivery ticket; and
if it is determined that the delivery ticket is valid, delivering the incoming reply message to the user's inbox.

28. The method as recited in claim 27, wherein the delivery ticket is contained by the incoming reply message and has been placed in the incoming reply message by the remote computer when the remote computer generated the incoming bounce message.

29. The method as recited in claim 28, further comprising, prior to receiving the incoming reply message, sending the electronic message from a computer associated with the user, the electronic message containing the delivery ticket.

30. The method as recited in claim 29, wherein the delivery ticket is included in a header of the message portion of the electronic message.

31. The method as recited in claim 29, wherein the electronic message, when sent by the computer associated with the user, is addressed to a recipient account that is different from an account that was used to generate the incoming reply message.

32. The method as recited in claim 27, further comprising, if it is determined that the incoming reply message does not include the delivery ticket, not delivering the incoming reply message to the user's inbox.

33. The method as recited in claim 27, further comprising, if it is determined that the delivery ticket is not valid, not delivering the incoming message to the user's inbox.

34. The method as recited in claim 27, wherein determining if the delivery ticket is valid comprises:
identifying a usage rule associated with the delivery ticket; and
determining whether the delivery ticket complies with the usage rule.

35. The method as recited in claim 34, wherein the usage rule associated with the delivery ticket is at least one of a single-use rule, a multiple-use rule, and a time-based rule.

36. In an authentication server included in an electronic messaging system, wherein a user sends an outgoing message and receives incoming messages, a method of authenticating an incoming message comprising:
generating an outgoing message containing a first delivery ticket, the first delivery ticket being valid for a specified period of time;
receiving an incoming message that purports to be a reply message based on the outgoing message;
determining whether the incoming message contains a second delivery ticket; and
determining whether receipt of the second delivery ticket was within the specified period of time.

37. The method as recited in claim 36, further comprising, after determining that receipt of the second delivery ticket is within the specified period of time, authenticating the second delivery ticket to determine whether the second delivery ticket is the same as the first delivery ticket and that the intended recipient of the incoming message was the sender of the outgoing message containing the first delivery ticket.

38. The method as recited in claim 37, further comprising, after determining that the second delivery ticket is the same as the first delivery ticket, delivering the incoming message to the user's inbox.

39. The method as recited in claim 37, further comprising, after determining that the second delivery ticket is the same as the first delivery ticket, referencing a database to determine whether receipt of the second delivery ticket complies with the defined usage of the first delivery ticket.

40. The method as recited in claim 39, further comprising, after determining that the receipt of the second delivery ticket complies with the defined usage of the first delivery ticket, delivering the incoming message to the user's inbox.

41. In an authentication server included in an electronic messaging system, wherein a user sends an outgoing message and receives incoming messages, a method of authenticating an incoming message comprising:
generating an outgoing message containing a first delivery ticket without storing the first delivery ticket;
receiving an incoming message that purports to be a reply message based on the outgoing message;
determining if the incoming message contains a second delivery ticket, the second delivery ticket including a usage indicator;
referencing a database to determine whether the second delivery ticket has been previously stored; and
upon determining that the second delivery ticket has not been previously stored, storing in the database the second delivery ticket along with the usage identified by the usage indicator.

42. The method as recited in claim 41, further comprising authenticating the second delivery ticket to determine whether the second delivery ticket is the same as the first delivery ticket.

43. The method as recited in claim 42, further comprising, after determining that the second delivery ticket is the same as the first delivery ticket, delivering the incoming message to the user's inbox.

44. The method as recited in claim 41, further comprising
identifying a specified period of time where the second delivery ticket is valid based on the usage indicator; and
deleting the second delivery ticket from the database when the specified period of time has expired.

45. An electronic message having a data structure generated by an authentication server, the electronic message comprising:
an envelope portion identifying the sender and the recipient, the envelope portion including a delivery ticket embedded in a field identifying the sender; the delivery ticket configured to be passed on to a reply message purporting to be based from the electronic message and used to authenticate the reply message without requiring any other filtering mechanism; and
a content portion containing data to be delivered to the recipient.

46. The electronic message as recited in claim 45, wherein the delivery ticket comprises a checksum.

47. The electronic message as recited in claim 46, wherein the checksum is derived using a private salt.

48. The electronic message as recited in claim 45, wherein the delivery ticket comprises a cryptographic portion.

49. The electronic message as recited in claim 45, wherein the delivery ticket comprises a digital signal portion.

50. An electronic message having a data structure generated by an authentication server, the electronic message comprising:
an envelope portion identifying the sender and the recipient; and
a content portion containing data to be delivered to the recipient, content portion comprising a message header portion, the message header portion including a delivery ticket embedded in a field uniquely identifying the message; the delivery ticket configured to be passed on to a reply message purporting to be based from the electronic message and used to authenticate the reply message without requiring any other filtering mechanism.

51. The electronic message as recited in claim 50, wherein the field uniquely identifying the message comprises a MESSAGE-ID field.

52. The electronic message as recited in claim 50, wherein the delivery ticket comprises a checksum.

53. The electronic message as recited in claim 52, wherein the checksum is derived using a private salt.

54. The electronic message as recited in claim 50, wherein the delivery ticket comprises a cryptographic portion.

55. The electronic message as recited in claim 50, wherein the delivery ticket comprises a digital signal portion.

56. In an authentication server in an electronic messaging system, a method of processing incoming messages directed to a user comprising:
receiving an incoming message purporting to be generated in response to an outgoing message sent by the user, the incoming message containing a delivery ticket;
using the delivery ticket to determine whether the incoming message is a response to an outgoing message sent by the user; and
based on the determination, delivering, or not delivering, the incoming message to the user's inbox.

57. The method as recited in claim 56, wherein using the delivery ticket to determine whether the incoming message is a response to an outgoing message sent by the user further comprises determining whether the delivery ticket was originally inserted in an outgoing message sent by the user.

58. The method as recited in claim 56, wherein using the delivery ticket to determine whether the incoming message is a response to an outgoing message sent by the user further comprises cryptographically authenticating the delivery ticket.

59. The method as recited in claim 56, wherein using the delivery ticket to determine whether the incoming message is a response to an outgoing message sent by the user further comprises matching the delivery ticket against a log of previously received delivery tickets.
